(19) United States
(12) Patent Application Publication
(10) Pub. No.: US 2015/0212357 A1
(43) Pub. Date: Jul. 30, 2015

(54) MANUFACTURING PROCESS FOR LIQUID CRYSTAL DISPLAY PANEL

(71) Applicant: Himax Display, Inc., Tainan City (TW)

(72) Inventors: Shun-Tai Huang, Tainan City (TW); Chih-Wei Huang, Tainan City (TW); Wei-Hsiao Chen, Tainan City (TW)

(73) Assignee: Himax Display, Inc., Tainan City (TW)

(21) Appl. No.: 14/163,869

(22) Filed: Jan. 24, 2014

(51) Int. Cl. G02F 1/1343; G02F 1/1335; G02F 1/1333

(52) U.S. Cl. CPC G02F 1/13439; G02F 1/133345; G02F 1/133516

(57) ABSTRACT

A manufacturing method for a liquid crystal display panel is provided. After providing a substrate having an insulation layer thereon, a first metal composite layer is formed on the insulation layer and then patterned to form at least one first opening through the first metal composite layer. A first intermediate dielectric layer is formed within the at least one first opening and a second intermediate dielectric layer is formed on the patterned first metal composite layer. The second intermediate dielectric layer is patterned to form second openings through the second intermediate dielectric layer. A second metal composite layer is formed on the patterned second intermediate dielectric layer and then patterned to form at least one third opening. Then, a third intermediate dielectric layer is formed within the at least one third opening.

### BACKGROUND

1. Technical Field

The present invention relates to a display device, and more particularly, to a manufacturing method for a liquid crystal display panel.

2. Description of Related Art

A liquid crystal on silicon (LCOS) display is one type of liquid crystal displays (LCDs), consisting of a liquid crystal layer sandwiched between a silicon wafer and a glass plate. The silicon chip is manufactured using standard complementary metal oxide semiconductor (CMOS) technology, which provides higher stability and reliability when compared with the LCD. At present, the LCOS display panels have been widely applied to video and media equipments, such as handy cameras, digital cameras, projection TVs, and multi-media overhead projectors.

In the LCOS panel, although the reflective pixel electrodes may cover the transistors without adversely affecting the optical property, the pixels of the LCOS panel have larger aperture ratios when compared to the pixels of the transmissive LCD panel. However, as the pixel size keeps shrinking, the aperture ratio of the pixel is reduced and the reflectance of the LCOS panel becomes lower.

### SUMMARY

The present invention is to provide a method for manufacturing a liquid crystal display panel with double mirror layers as the reflective structure, which enhances light reflectance and offer higher brightness for image display.

The present invention provides a manufacturing method for a liquid crystal display pane comprising the following steps. After providing a substrate having an insulation layer thereon, a first metal composite layer is formed on the insulation layer and then patterned to form at least one first opening through the first metal composite layer. A first intermediate dielectric layer is formed within the at least one first opening and a second intermediate dielectric layer is formed on the patterned first metal composite layer. The second intermediate dielectric layer is patterned to form second openings through the second intermediate dielectric layer. A second metal composite layer is formed on the patterned second intermediate dielectric layer and then patterned to form at least one third opening. Then, a third intermediate dielectric layer is formed within the at least one third opening.

In an embodiment, the step of forming the first metal composite layer includes forming sequentially a first layer, a second layer and a first metal layer on the insulation layer.

In an embodiment, the step of forming the first layer includes forming a titanium layer by sputtering or physical vapor deposition (PVD) and forming the second layer includes forming a titanium nitride (TiN) layer by PVD or chemical vapor deposition (CVD).

In an embodiment, the step of forming the first metal layer includes forming a layer made of aluminium, titanium, tantalum, silver, gold, copper or platinum by sputtering, PVD or plating.

In an embodiment, a thickness of the first metal composite layer ranges from 200 nm to 1000 nm.

In an embodiment, the second intermediate dielectric layer includes silicon oxide, silicon oxynitride and/or silicon nitride, formed by CVD.

In an embodiment, a thickness of the second intermediate dielectric layer ranges from 300 angstroms to 1800 angstroms.

In an embodiment, the step of forming the second metal composite layer includes forming sequentially a third layer, a fourth layer and a second metal layer.

In an embodiment, the step of forming the third layer includes forming a titanium layer by sputtering or physical vapor deposition (PVD) and forming the fourth layer includes forming a titanium nitride (TiN) layer by PVD or chemical vapor deposition (CVD).

In an embodiment, the third layer and the fourth layer 554 are formed conformally to cover surfaces of the second openings without filling up the second openings.

In an embodiment, the step of forming the second metal layer includes forming a layer made of aluminium, titanium, tantalum, silver, gold, copper or platinum by sputtering, PVD or plating.

In an embodiment, a thickness of the second metal composite layer ranges from 300 angstroms to 1800 angstroms.

In an embodiment, the method further comprises forming another insulation layer on the patterned second metal composite layer and forming a plurality of pixel electrodes and a color filter array above the patterned second metal composite layer.

In an embodiment, the method further comprises forming a liquid crystal layer and a top substrate over the color filter array.

In order to make the aforementioned and other objects, features and advantages of the present invention comprehensible, several non-limiting embodiments accompanied with figures are described in detail below.

### BRIEF DESCRIPTION OF THE DRAWINGS

The accompanying drawings are included to provide a further understanding of this invention, and are incorporated in and constitute a part of this specification. The drawings illustrate embodiments of the invention and, together with the description, serve to explain the principles of the invention.

FIG. 1 is a schematic cross-sectional view of a display panel according to an embodiment of the present invention.

FIGS. 2A-2J illustrate the process flow of a method of the reflective structure of the display panel according to one embodiment of the present invention.

FIG. 3 is a diagram showing the relationship of the reflectance of the display panel versus the wavelength of the light.

### DESCRIPTION OF EMBODIMENTS

Reference will now be made in detail to the embodiments of the invention, examples of which are illustrated in the accompanying drawings. Wherever possible, the same reference numbers are used in the drawings and the description to refer to the same or like elements.

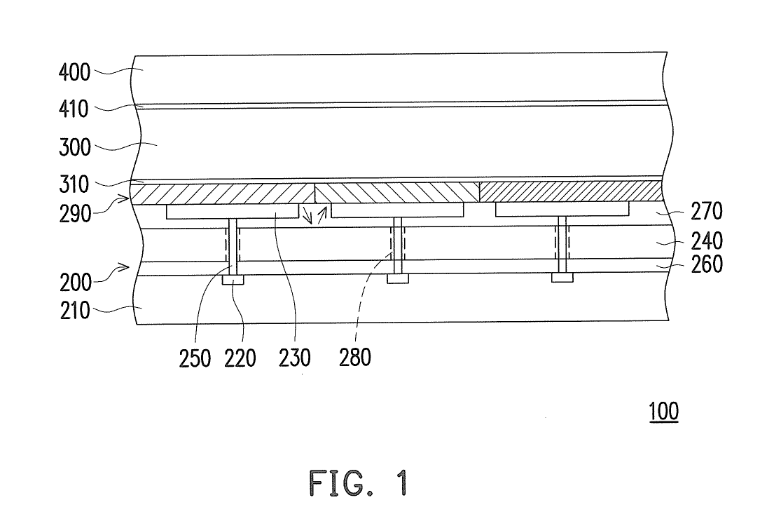

FIG. 1 is a schematic cross-sectional view of a display panel according to an embodiment of the present invention. Referring to FIG. 1, the display panel 100 in this embodiment includes an active matrix 200, a liquid crystal layer 300 and a top substrate 400. The active matrix 200 includes a bottom substrate 210, a plurality of active devices 220, a plurality of pixel electrodes 230, a reflective structure 240 and a plurality of conductive elements 250.

In this embodiment, the bottom substrate 210 may be a silicon substrate and the top substrate may be a glass substrate, for example. In this case, the display panel 100 is a LCOS display panel and the active matrix 200 in this embodiment is an active matrix of the LCOS display panel. The active devices 220 may be transistors arranged as an array in the substrate 210. In this embodiment, the pixel electrodes 230 are reflective pixel electrodes and are respectively disposed above the active devices 220. The pixel electrodes 230 may be made of a metal, for example, aluminium. The reflective structure 240 is disposed between the substrate 210 and the pixel electrodes 230. The conductive elements 250 penetrate through the reflective structure 240 and connect the pixel electrodes 230 and the active devices 220. The conductive elements 250 may be made of a metal or a metal alloy, for example.

The display panel 100 further includes a first insulation layer 260 and a second insulation layer 270. The first insulation layer 260 is disposed between the substrate 210 and the reflective structure 240. The second insulation layer 270 is disposed between the reflective structure 240 and the pixel electrodes 230. Moreover, the conductive elements 250 may be isolated from the reflective structure 240 by the insulation layers 280. The display panel 100 also includes a color filter array 290 disposed on the pixel electrodes 230 and an alignment layer 310 disposed on the color filter array 290.

The opposite substrate 400 may further include another alignment layer 410 disposed between the transparent substrate 400 and the liquid crystal layer 300. Specifically, the liquid crystal layer 300 is disposed between the alignment layers 310, 410 and between the active matrix 200 and the substrate 400.

For the display panel 100 according to this embodiment, light not reflected by the pixel electrodes 230 can be reflected by the reflective structure 240. Specifically, the light passing through the gaps between any two adjacent pixel electrodes 230 is reflected by the reflective structure 240 (shown by arrows). Consequently, the reflectance of the display panel 100 is enhanced. Therefore, the display panel 100 is able to provide an image with higher brightness. In this way, even if the pixel size is reduced and the aperture ratio of the pixel is reduced, the display panel 100 still maintains high reflectance.

In the following context, the aforementioned reflective structure and the manufacturing process thereof will be described in further details. Other elements of the display panel may be fabricated using the well-known technology and detailed explanation of the fabrication process and the suitable material choices are omitted.

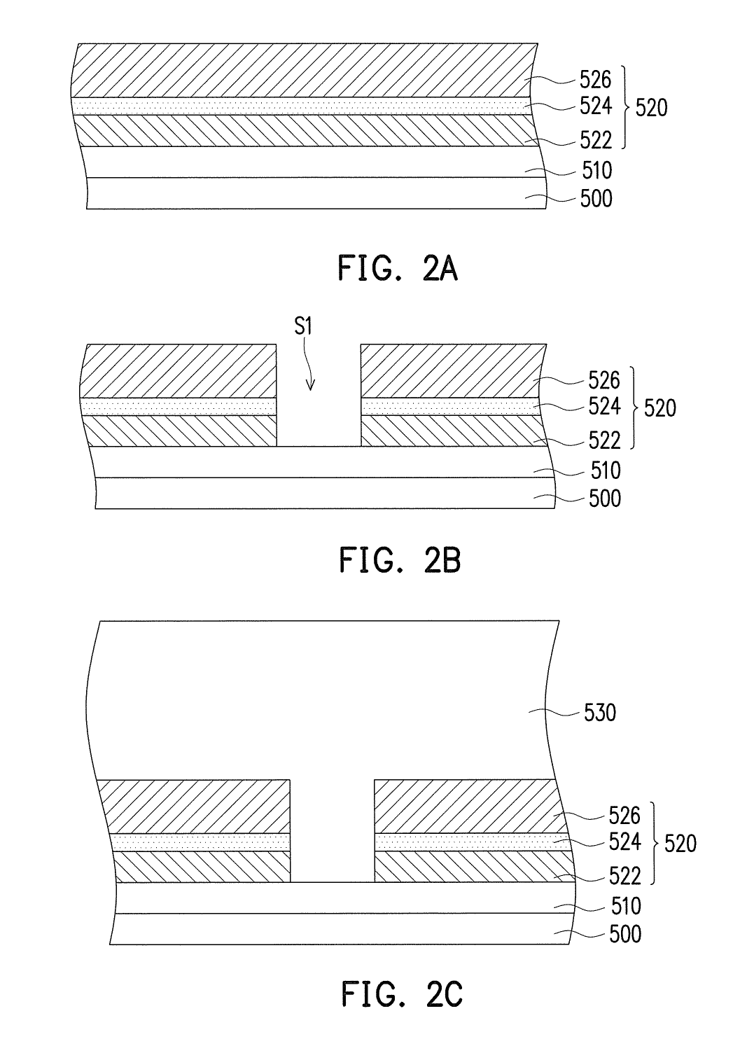

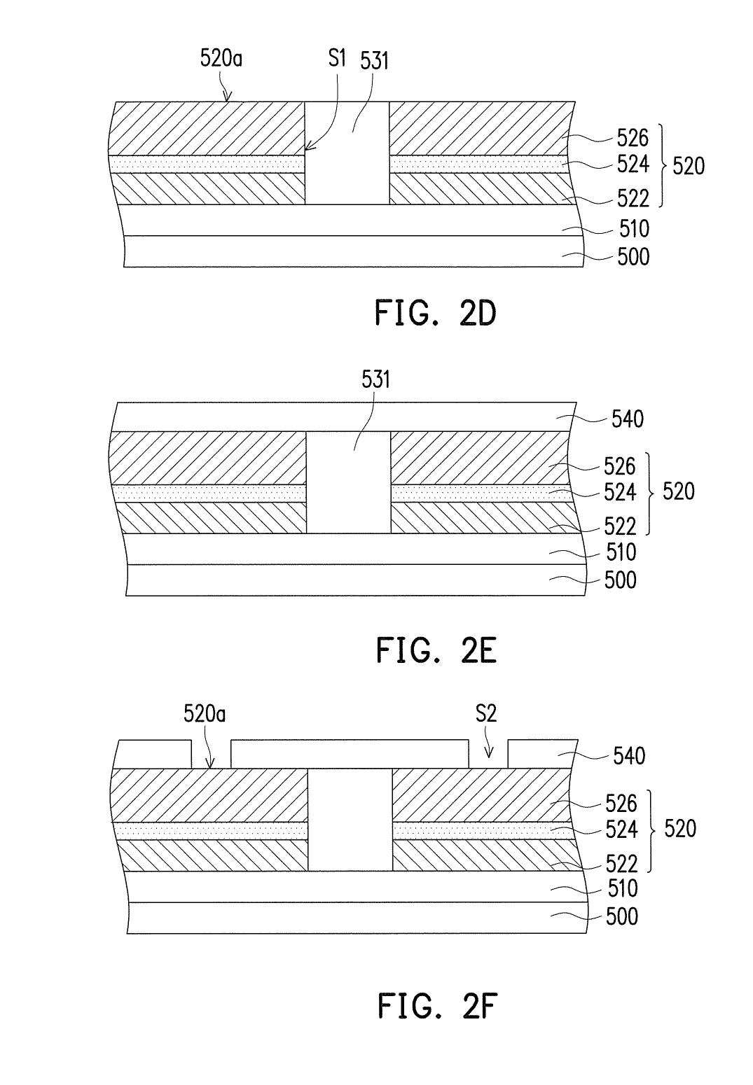

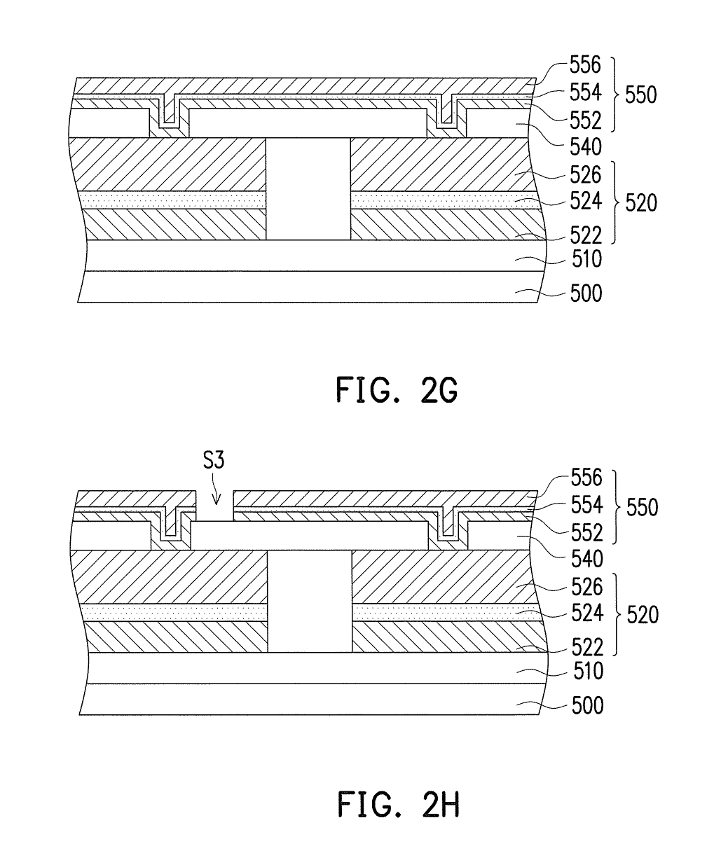

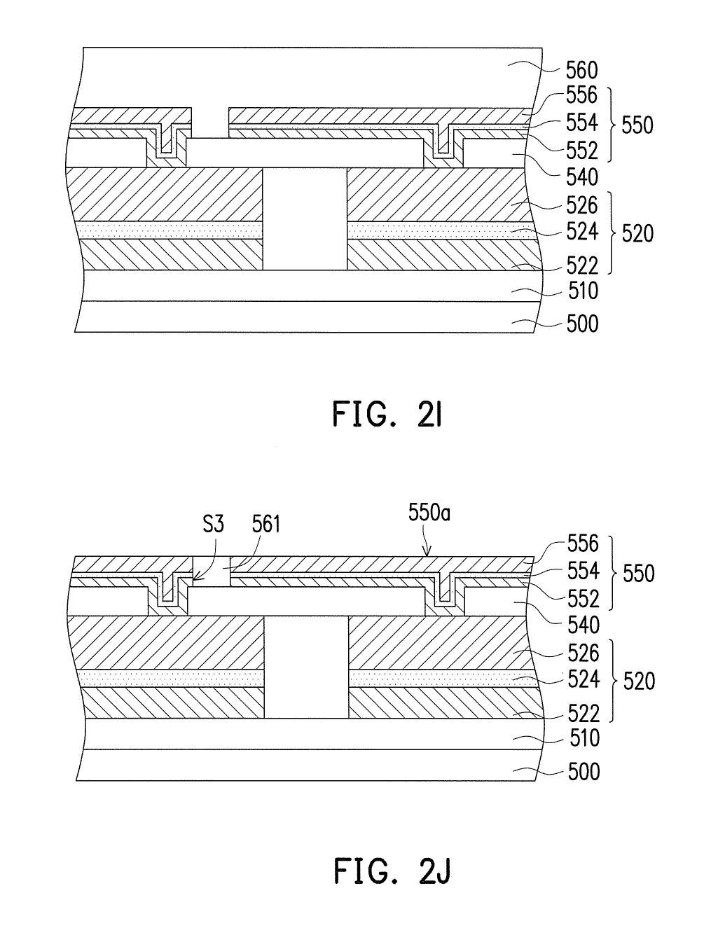

FIGS. 2A-2J illustrate the process flow of a method of the reflective structure of the display panel according to one embodiment of the present invention.

Referring to FIG. 2A, a substrate 500 having an insulation layer 510 thereon is provided. The substrate 500, for example, may be a silicon substrate having various active devices and other elements formed therein. A first metal composite layer 520 is formed on the insulation layer 510. The first metal composite layer 520 is formed by sequentially forming a first layer 522, a second layer 524 and a first metal layer 526. The first layer 522 may be a titanium (Ti) layer formed by sputtering or physical vapor deposition (PVD), for example. The second layer 524 may be a titanium nitride (TiN) layer formed by PVD or chemical vapor deposition (CVD), for example. The first metal layer 526 may be made of a conductive material with a high reflectivity, such as aluminium (Al), titanium (Ti), tantalum (Ta), silver (Ag), gold (Au), copper (Cu) or platinum (Pt) formed by sputtering, PVD or plating. Preferably, the first metal layer 526 may be made of Al. The first metal composite layer 520 functions as a minor layer for reflecting light passing through the above pixel electrodes. The thickness of the first metal composite layer 520 is not particularly limited and may range from 200 nm to 1000 nm preferably xxxx run.

Referring to FIG. 2B, the first metal composite layer 520 is patterned by photolithography processes to form at least one opening S1 passing through the first metal composite layer 520.

Referring to FIG. 2C, a first intermediate dielectric layer 530 is formed on the patterned first metal composite layer 520 and fills up the opening S1. The first intermediate dielectric layer 530 may include silicon oxide, silicon oxynitride and/or silicon nitride, and may be formed by CVD, for example.

Referring to FIG. 2D, a planarization process is performed to remove the first intermediate dielectric layer 530 until the top surface 520a of the first metal composite layer 520 is exposed and only the remaining portion 531 (i.e. the first intermediate dielectric layer 530 filled within the opening S1) is remained. The planarization process may include a chemical mechanical polishing process to remove the majority of the first intermediate dielectric layer 530 and then an etching back process to remove the first intermediate dielectric layer 530 until the underlying surface 520a is exposed.

Referring to FIG. 2E, a second intermediate dielectric layer 540 is formed on the first metal composite layer 520 and covers the remaining portion 531. The second intermediate dielectric layer 540 may include silicon oxide, silicon oxynitride and/or silicon nitride, and may be formed by CVD, for example. The thickness of the second intermediate dielectric layer 540 is not particularly limited and may range from 300 angstroms to 1800 angstroms, preferably 1000 angstroms, for example.

Referring to FIG. 2F, the second intermediate dielectric layer 540 is patterned by photolithography processes to faun openings S2 passing through the second intermediate dielectric layer 540. The openings S2 exposes the top surface 520a of the first metal composite layer 520.

Referring to FIG. 2G, a second metal composite layer 550 is formed on the patterned second intermediate dielectric layer 540. The second metal composite layer 550 is formed by sequentially forming a third layer 552, a fourth layer 554 and a second metal layer 556. The third layer 552 and the fourth layer 554 are thin layers & glued conformally to the profile of the openings S2, rather than filling up the openings S2. Instead, the second metal layer 556 fills up the openings S2 and covers the third layer 552 and the fourth layer 554. The third layer 552 may be a titanium (Ti) layer formed by sputtering or PVD, for example. The fourth layer 554 may be a titanium nitride (TiN) layer formed by CVD or PVD, for example. The second metal layer 556 may be made of a conductive material with a high reflectivity, such as Al, Ti, Ta, Ag, Au, Cu or Pt, formed by sputtering, PVD or plating. Preferably, the second metal layer 556 may be made of Al. The second metal composite layer 550 functions as another mirror layer for reflecting light passing through the above pixel electrodes. The thickness of second intermediate dielectric layer 540 and the second metal composite layer 550 are not particularly limited and may be adjusted to achieve the optimal optical properties, especially for constructive interference effects. The thickness of the second metal composite layer 550 is not particularly limited and may range from 300 angstroms to 1800 angstroms, preferably 1000 angstroms. The materials of the second mirror layer 550 may be identical to or different from those of the first mirror layer 520. The mirror layers 520, 550 may be formed by similar processes, e.g., a physical vapor deposition (PVD) process but differ in the process duration so as to be different in thickness.

Referring to FIG. 2H, then, the second metal composite layer 550 is patterned by photolithography processes to form at least one opening S3 and the depth of the opening S3 may be controlled to expose the underlying second intermediate dielectric layer 540.

Referring to FIG. 21, a third intermediate dielectric layer 560 is formed on the patterned second metal composite layer 550 and fills up the opening S3. The third intermediate dielectric layer 560 may include silicon oxide, silicon oxynitride and/or silicon nitride, and may be formed by CVD, for example.

Referring to FIG. 2J, a planarization process is performed to remove the third intermediate dielectric layer 560 until the top surface 550a of the second metal composite layer 550 is exposed and only the remaining portion 561 (i.e. the third intermediate dielectric layer 560 filled within the opening S3) is remained. The planarization process may include a chemical mechanical polishing process to remove the majority of the third intermediate dielectric layer 560 and then an etching back process to remove the third intermediate dielectric layer 560 until the underlying surface 550a is exposed.

The aforementioned reflective structure mainly includes the composite structure including the first mirror layer 520, the intermediate dielectric layer 540 and the second mirror layer 550 as well as the remaining portions 531 and 561.

In general, the process steps described above are merely parts of the process steps for manufacturing the complete structure of the display panel, and the fabrication processes of other elements of the display panel will not be described in details. After providing the bottom substrate having a plurality of active devices therein and the insulation layer thereon, the reflective structure is fabricated through the above processes. Subsequently, after forming another insulation layer on the patterned second metal composite layer and forming a plurality of conductive elements, a plurality of pixel electrodes and a color filter array are formed above the patterned second metal composite layer. Afterwards, a liquid crystal layer and a top substrate are formed over the color filter array.

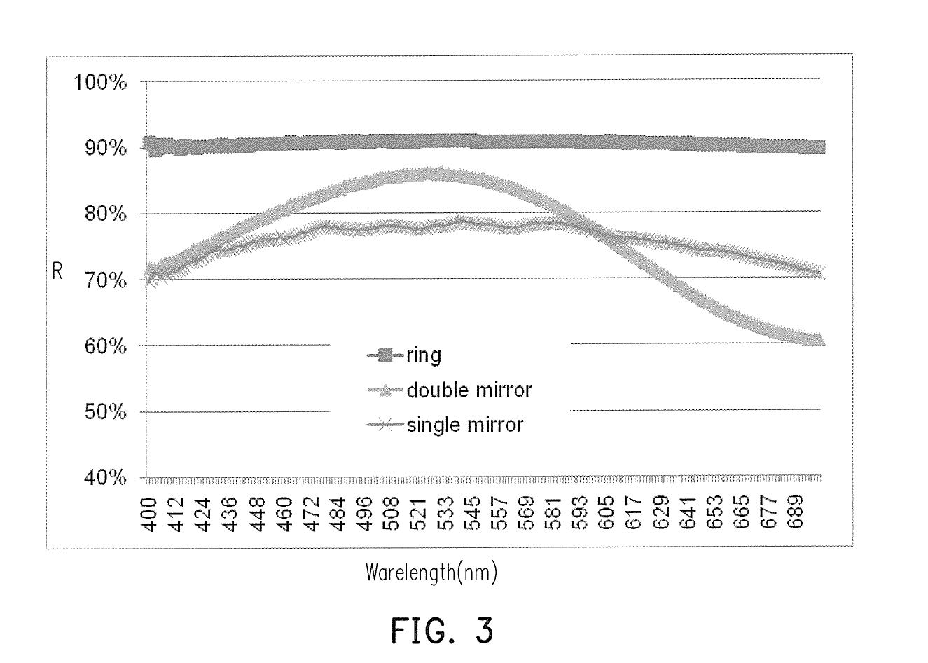

As shown in FIG. 3, compared with the display panels using a single minor layer as the reflective structure, the display panel using double mirror layers as the reflective structure as proposed in this invention can offer higher reflectance, especially in the green light wavelengths. Also, compared with the display panels using pure Al as the reflective structure, the display panel with the double mirror layers can reach comparable reflectance. The values of the reflectance of these panels at 525 nm are listed in Table 1.

TABLE 1

| Wavelength (nm) | Al ring | Double mirror | Single mirror |
|---|---|---|---|
| 525 | 90.9% | 86.0% | 77.7% |

Through the design of the double mirror layers located under the pixel electrodes for reflecting the light, the display panel(s) can achieve a better reflection performance, especially for the green light wavelength range. Moreover, such design is beneficial for display panels of small pixels.

Accordingly, the present invention provides a LCD panel having the double mirror reflective structure to boost the reflectance of the light, which provides high resolution images with higher brightness.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

1. A manufacturing method for a liquid crystal display panel, comprising:
providing a substrate having and an insulation layer thereon;
forming a first metal composite layer on the insulation layer;
patterning the first metal composite layer to form at least one first opening through the first metal composite layer;
forming a first intermediate dielectric layer on the patterned first metal composite layer and filling up the at least one first opening;
performing a first planarization process to remove the first intermediate dielectric layer until the patterned first metal composite layer is exposed;
forming a second intermediate dielectric layer on the patterned first metal composite layer;
patterning the second intermediate dielectric layer to form second openings through the second intermediate dielectric layer;
forming a second metal composite layer on the patterned second intermediate dielectric layer;
patterning the second metal composite layer to form at least one third opening;
forming a third intermediate dielectric layer on the patterned second metal composite layer and filling up the at least one third opening;
performing a second planarization process to remove the third intermediate dielectric layer until the patterned second metal composite layer is exposed: forming an insulation layer on the patterned second metal composite layer; and
forming a plurality of pixel electrodes and a color filter array on the insulation layer and above the patterned second metal composite layer, wherein the patterned first and second metal composite layers function as mirror layers for reflecting light.

2. The method of claim 1, wherein forming the first metal composite layer includes forming sequentially a first layer, a second layer and a first metal layer on the insulation layer.

3. The method of claim 2, wherein forming the first layer includes forming a titanium layer by sputtering or physical vapor deposition (PVD) and forming the second layer includes forming a titanium nitride (TiN) layer by PVD or chemical vapor deposition (CVD).

4. The method of claim 3, wherein forming the first metal layer includes forming a layer made of aluminium, titanium, tantalum, silver, gold, copper or platinum by sputtering, PVD or plating.

5. The method of claim 1, wherein a thickness of the first metal composite layer ranges from 200 nm to 1000 nm

6. The method of claim 1, wherein the second intermediate dielectric layer includes silicon oxide, silicon oxynitride and/or silicon nitride, formed by CVD.

7. The method of claim 1, wherein a thickness of the second intermediate dielectric layer ranges from 300 angstroms to 1800 angstroms.

8. The method of claim 1, wherein forming the second metal composite layer includes forming sequentially a third layer, a fourth layer and a second metal layer.

9. The method of claim 8, wherein forming the third layer includes forming a titanium layer by sputtering or physical vapor deposition (PVD) and forming the fourth layer includes forming a titanium nitride (TiN) layer by PVD or chemical vapor deposition (CVD).

10. The method of claim 9, wherein the third layer and the fourth layer are formed conformally to cover surfaces of the second openings without filling up the second openings.

11. The method of claim 9, wherein forming the second metal layer includes forming a layer made of aluminium, titanium, tantalum, silver, gold, copper or platinum by sputtering, PVD or plating.

12. The method of claim 1, wherein a thickness of the second metal composite layer ranges from 300 angstroms to 1800 angstroms.

13. (canceled)

14. The method of claim 1, further comprising forming a liquid crystal layer and a top substrate over the color filter array.
